(19) United States
(12) Patent Application Publication
(10) Pub. No.: US 2023/0274683 A1
(43) Pub. Date: Aug. 31, 2023

(54) DRIVE CIRCUIT

(71) Applicant: SONY SEMICONDUCTOR SOLUTIONS CORPORATION, Kanagawa (JP)

(72) Inventor: Kota MASE, Kanagawa (JP)

(73) Assignee: SONY SEMICONDUCTOR SOLUTIONS CORPORATION, Kanagawa (JP)

(21) Appl. No.: 18/007,026

(22) PCT Filed: Jun. 24, 2021
(86) PCT No.: PCT/JP2021/024028

§ 371 Date: Jan. 26, 2023

(30) Foreign Application Priority Data
Aug. 7, 2020 (JP) 2020-135176

(51) Int. Cl. G09G 3/20; G09G 3/36

(52) U.S. Cl. CPC G09G 3/2048; G09G 3/3611; G09G 3/2022; G09G 2320/0673; G09G 2320/0247; G09G 2320/0276

(57) ABSTRACT

To suppress disturbance of a video or the like. A drive circuit is a drive circuit that drives each picture element in a display device arranged in a matrix, and includes a noise imparting unit. In a case where the gradation level of the picture element is a predetermined gradation level, the noise imparting unit imparts one of a plurality of correction values to the gradation level data of the picture element.

### TECHNICAL FIELD

The present disclosure relates to a drive circuit.

### BACKGROUND ART

Nowadays, a device that implements display such as a projector or the like by digital driving is widely used. In a digitally driven display device, gradation level display is implemented using, for example, a pulse width modulation (PWM) method. In a display device such as a projector or the like using a PWM method, a black streak is generated due to disturbance of liquid crystal in projection near intensity at which modulation time is greatly changed. This black streak can be reduced, for example, by adding a correction value to gradation level data for each picture element in all picture elements for each frame, but this correction intensity is in a trade-off relationship with the occurrence of flicker. For this reason, it is difficult to set a strong correction value.

### CITATION LIST

### Patent Document

Patent Document 1: JP 2013-50679 A

### SUMMARY OF THE INVENTION

### Problems to be Solved by the Invention

Therefore, the present disclosure provides a drive circuit, a drive method, and a display device that suppress disturbance of a video or the like.

### Solutions to Problems

According to an embodiment, a drive circuit is a drive circuit that drives picture elements in a display device arranged in a matrix, the drive circuit including a noise imparting unit that imparts one of a plurality of correction values to gradation level data of a picture element of the picture elements in a case where a gradation level of the picture element is a predetermined gradation level.

The gradation level data may be a signal encoded in a pulse width modulation (PWM) format or a phase modulation (PM) format indicating control of continuing an on state or an off state of the picture element in a period of subframes time-divided in one frame, and control may be performed such that the picture element emits the signal encoded along a time series.

The noise imparting unit may set a basic value on the basis of a predetermined gradation level value, and impart a correction value whose absolute value is within the basic value to the gradation level data of the picture element.

A maximum value of the gradation level data may be n (n is any natural number), and the predetermined gradation level may include at least a gradation level indicating a gradation level value of floor ((n−1)/2).

The predetermined gradation level may include a plurality of gradation level values, and a correction value may be imparted to the gradation level data of the picture element of the gradation level of floor ((n−1)/2) on the basis of the basic value larger than the picture element of another predetermined gradation level.

The noise imparting unit may impart a correction value obtained by reversing positive and negative of a correction value imparted to a previous frame to the gradation level data of each of the picture elements to which the correction value is imparted.

The noise imparting unit may impart a correction value that randomly varies to the gradation level data of the picture element.

The noise imparting unit may impart a correction value that periodically varies to the gradation level data of each of the picture elements to which the correction value is imparted.

The noise imparting unit may impart a correction value to the gradation level data of the picture element in a case where a period in which phases of the gradation level data in the PWM format for two picture elements adjacent to each other in a same frame are different is a predetermined period or longer.

The drive circuit may further include a gamma correction unit that executes gamma correction on the gradation level data, the gamma correction unit switching a plurality of gamma curves for each frame.

The gamma correction unit may execute gamma correction on the basis of a gamma curve for correcting gradation levels having same values in positive and negative from a reference gamma curve.

The gamma correction unit may execute gamma correction from the reference gamma curve on the basis of a gamma curve in which at least a central gradation level value is a value different from the reference gamma curve.

The gamma correction unit may execute gamma correction at least on the basis of a gamma curve having a gradation level different from the reference gamma curve in a gradation level in which a period in which phases of the gradation level data in the PWM format for two picture elements adjacent to each other in a same frame are different is a predetermined period or longer.

The gamma correction unit may execute gamma correction at least on the basis of a gamma curve having a gradation level in which a difference from the reference gamma curve is larger than previous and subsequent gradation level values in a gradation level in which a period in which phases of the gradation level data in the PWM format for two picture elements adjacent to each other in a same frame are different is a predetermined period or longer.

According to an embodiment, a drive circuit is a drive circuit that drives picture elements in a display device arranged in a matrix, the drive circuit including a gamma correction unit that executes gamma correction on gradation level data for a picture element of the picture elements, the gamma correction unit switching a plurality of gamma curves for each frame.

### BRIEF DESCRIPTION OF DRAWINGS

FIG. 1 is a block diagram schematically illustrating a display device according to an embodiment.

FIG. 2 is a block diagram schematically illustrating a signal processing circuit according to an embodiment.

FIG. 3 is a diagram illustrating an example of gradation level processing by a PWM method.

FIG. 4 is a block diagram illustrating an example of a gamma correction circuit according to an embodiment.

FIG. 5 is a diagram illustrating an example of gamma correction according to an embodiment.

FIG. 6 is a diagram illustrating an example of gradation output by gamma correction according to an embodiment.

FIG. 7 is a diagram illustrating an example of gamma correction according to an embodiment.

FIG. 8 is a diagram illustrating an example of gamma correction according to an embodiment.

FIG. 9 is a diagram illustrating an example of gamma correction according to an embodiment.

FIG. 10 is a diagram illustrating a position example of noise imparting according to an embodiment.

FIG. 11 is a flowchart illustrating processing of a gamma correction circuit according to an embodiment.

FIG. 12 is a flowchart illustrating processing of a noise imparting circuit according to an embodiment.

### MODE FOR CARRYING OUT THE INVENTION

Hereinafter, embodiments of the present disclosure will be described with reference to the drawings. The drawings are used for description, and the shape and size of the configuration of each unit in the actual device, the ratio of the size to other configurations, and the like are not necessarily as illustrated in the drawings. Furthermore, since the drawings are illustrated in a simplified manner, configurations necessary for implementation other than those illustrated in the drawings are appropriately provided.

### [Display Device]

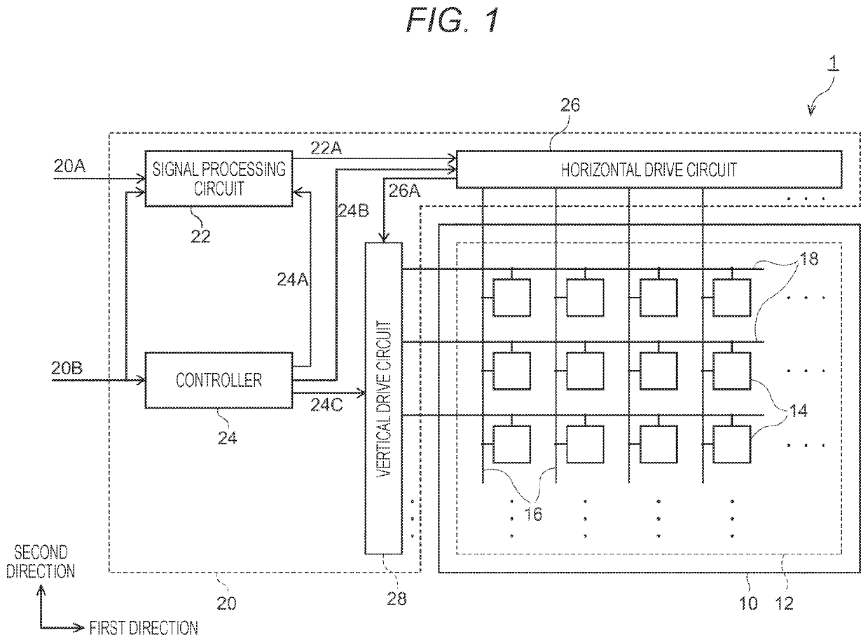

FIG. 1 is a block diagram schematically illustrating a display device according to an embodiment. A display device 1 includes a display panel 10 and a drive circuit 20.

The display panel 10 includes a picture element region 12. The display panel 10 outputs information of an image and a video (hereinafter, referred to as a video or the like). This display includes, for example, a picture element that controls light emitted from a light source by liquid crystal in the picture element region 12.

The picture element region 12 includes picture elements 14, data lines 16, and scanning lines 18.

The picture elements 14 are provided, for example, in an array along a first direction (horizontal direction) and a second direction (vertical direction). This picture element is provided, for example, in a region where each data line 16 and scanning line 18 intersect. A data line 16 and a scanning line 18 corresponding to each picture element 14 are connected to each picture element. The picture element 14 includes, for example, a liquid crystal cell. Then, the luminance of the light emitted from the backlight or the like is controlled and output by the liquid crystal cell.

The drive circuit 20 controls the gradation level by performing PWM driving of the picture elements 14 along the time series on the basis of the gradation level data. The picture element 14 expresses a gradation level on the basis of a ratio between an on state and an off state of light emission in one frame. That is, in the display device 1, the gradation level is expressed by time-integrating the light emission state of the picture element 14.

The picture element 14 outputs, for example, gradation level light on the basis of an input signal. This gradation level may be controlled using a liquid crystal element or the like such as a liquid crystal cell or the like. Furthermore, the picture element 14 may be a picture element incorporating a memory. The memory may be, for example, a static random access memory (SRAM), a dynamic random access memory (DRAM), or the like.

The data line 16 transmits data for outputting video information and the like to the picture element 14. For example, the drive circuit 20 outputs a data signal based on color information and intensity information emitted by each of the picture elements 14 via the data line 16, and controls a light emission state in each of the picture elements 14.

The scanning line 18 outputs a scanning signal for selecting a line of the picture elements 14 continuous in the second direction to the picture elements 14. For example, the drive circuit 20 outputs a signal for selecting to which picture element among the picture elements 14 continuous in the vertical direction via the scanning line 18 a data signal is to be supplied.

The drive circuit 20 outputs a data signal for the picture element 14 in the data line 16, and selects which picture element 14 the data signal is supplied to by propagating a control signal to the scanning line 18. In this manner, in each picture element 14, gradation level to be output is controlled by the corresponding data line 16 and scanning line 18. For example, a common data line 16 is connected to the picture elements 14 provided along the second direction, and this connection state is controlled by the scanning lines 18 corresponding to the respective picture elements 14. In this manner, the scanning line 18 control the gradation level of the light output from the picture elements 14 belonging to the selected row on the basis of the signal applied to the data line 16.

The drive circuit 20 includes a signal processing circuit 22, a controller 24, a horizontal drive circuit 26, and a vertical drive circuit 28. The drive circuit 20 is a circuit that outputs a video signal and a control signal to the picture elements 14 so as to display a video or the like on the display panel 10.

A video signal 20A and a synchronization signal 20B supplied from a host device (not illustrated) are input to the signal processing circuit 22. The video signal 20A includes gradation level data, and the signal processing circuit 22 converts the video signal 20A into a PWM signal 22A according to the gradation level data, and outputs the PWM signal to the horizontal drive circuit 26. The signal processing executed in the signal processing circuit 22 includes, for example, processing related to gradient for avoiding image deterioration in the present disclosure in addition to image quality adjustment processing. Details of the signal processing circuit 22 and the contents of the signal processing will be described later.

The controller 24 is a circuit that generates control signals 24A, 24B, and 24C for controlling operation timings of the signal processing circuit 22, the horizontal drive circuit 26, and the vertical drive circuit 28 from the synchronization signal 20B. The synchronization signal 20B may be, for example, a horizontal synchronization signal, a vertical synchronization signal, a clock signal, or the like. The control signals 24A, 24B, and 24C may be, for example, a clock signal, a latch signal, a frame start signal, a subfield start signal, or the like.

The horizontal drive circuit 26 outputs a data signal to each of the data lines 16 on the basis of the PWM signal 22A and the control signal 24B.

On the basis of the control signal 26A output from the horizontal drive circuit 26 and the address data specified from the control signal 24C, the vertical drive circuit 28 outputs a scanning signal for selecting each picture element 14 row by row to the scanning line 18. For example, the vertical drive circuit 28 outputs a scanning signal to each of the scanning lines 18 in a predetermined order, and executes control to select a line of the picture elements 14 to which a data signal is supplied.

In this manner, the drive circuit 20 executes signal processing on the received video signal 20A, and executes control in which the picture element 14 emits light at timing based on the PWM signal 22A and the synchronization signal 20B as a result of the signal processing.

### [Drive Circuit]

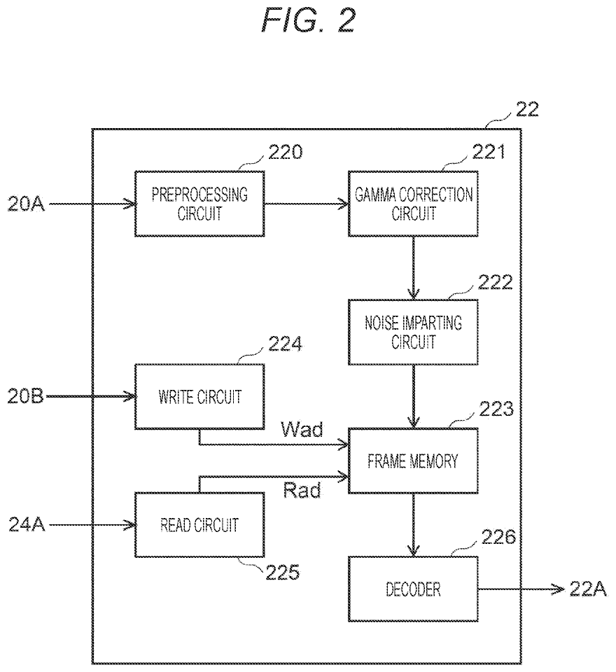

FIG. 2 schematically illustrates an example of the signal processing circuit 22 according to an embodiment. The signal processing circuit 22 includes a preprocessing circuit 220, a gamma correction circuit 221, a noise imparting circuit 222, a frame memory 223, a write circuit 224, a read circuit 225, and a decoder 226.

The preprocessing circuit 220 executes various processes for outputting the video signal 20A as an appropriate video. The preprocessing circuit 220 executes, as preprocessing, for example, signal processing such as distortion correction, various types of filter processing, and the like, and image processing such as luminance adjustment, various types of image filter processing, and the like. This preprocessing is not limited to the description described above, and is processing including various types of processing executed to generate appropriate video data.

The gamma correction circuit 221 performs gamma correction on the video signal processed by the preprocessing circuit 220, and corrects the luminance value of the light output from the picture element 14. The gamma correction circuit 221 performs the gamma correction, and generates a signal for lowering the visibility of the black streak caused by the digital driving in the image, the video, and the like displayed on the display panel 10, for example. Details of the gamma correction will be described later.

The noise imparting circuit 222 imparts random noise to the video signal subjected to the gamma correction by the gamma correction circuit 221, and corrects the luminance value of the light output from the picture element 14. For example, similarly to the gamma correction circuit 221, the noise imparting circuit 222 generates a signal that lowers the visibility of the black streak caused by the digital driving in the image, the video, and the like displayed on display panel 10 by imparting the noise. Details of this noise imparting will also be described later.

The frame memory 223 is a video display memory having a storage capacity larger than at least the resolution of the picture element region 12. The frame memory 223 can save, for example, an address in the first direction, an address in the second direction, and gradation level data of the picture element 14 associated with these addresses.

The write circuit 224 generates the write address Wad of the video signal subjected to the noise imparting process by the noise imparting circuit 222 on the basis of the synchronization signal 20B, and outputs the write address Wad to the frame memory 223 in synchronization with the synchronization signal 20B. The write address Wad is, for example, information including an address in the first direction and an address in the second direction.

The read circuit 225 generates a read address Rad on the basis of the control signal 24A and outputs the read address Rad to the frame memory 223.

The decoder 226 converts the gradation level data output from the frame memory 223 into a PWM signal 22A and outputs the PWM signal.

Note that, in FIG. 2, the signal output from the preprocessing circuit 220 is input in the order of the gamma correction circuit 221 and the noise imparting circuit 222, but the present invention is not limited thereto. For example, the noise imparting circuit 222 may be connected after the preprocessing circuit 220, and the gamma correction circuit 221 may be connected between the noise imparting circuit 222 and the frame memory 223. Furthermore, the present invention is not limited thereto, and the signal processing circuit 22 may not include any one of the gamma correction circuit 221 and the noise imparting circuit 222. That is, in the following description, both gamma correction and noise imparting are applied, but the present invention is not limited thereto, and the signal processing circuit 22 may include a circuit that executes gradation level conversion of any one of the gradation level processing.

### [Gradation Level Processing by PWM Method]

The picture element 14 generates and displays a luminance value corresponding to the gradation level in a pseudo manner by switching gradation levels of 0 (minimum value) and 1 (maximum value) in the frame by time division according to the PWM signal 22A.

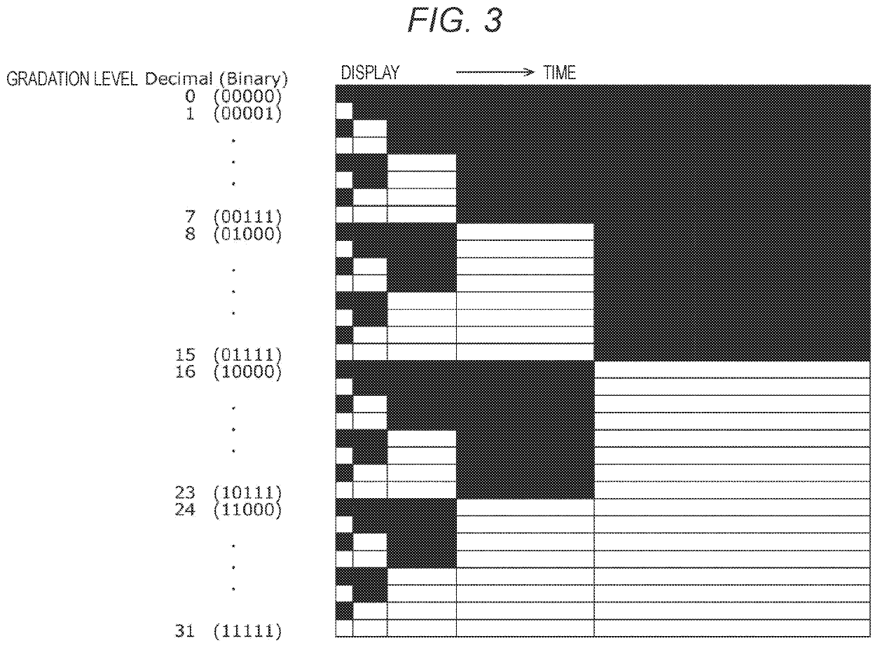

FIG. 3 is a diagram illustrating an example of gradation level switching in the PWM method. An example in which the display is represented by 32 gradation levels will be described with respect to control of one frame. Note that the number of gradation levels is not limited to 32, and may be more, for example, 64, 128, . . . , or the like. Furthermore, the number of gradation levels does not have to be a power of 2, and even in this case, processing similar to that of the display device according to the present embodiment can be executed between bits in which values in which the influence of inversion can be large are continuous or close to each other.

In FIG. 3, gradation levels are expressed in decimal and binary. The display timing for this gradation level value, that is, the switching timing of 0 and 1 of each picture element is illustrated on the right. For example, in a case where the gradation level value is expressed by the PWM method, the gradation level value is time-divided into subframes in which 0 or 1 is displayed during one unit time (for example, 1 msec or the like), two unit times, four unit times, eight unit times, and 16 unit times. Each picture element expresses a gradation level by a combination of subframes by switching which subframe is to be turned off (0) or turned on (1) on the basis of a gradation level value coded in a binary number.

For example, when the gradation level value is 0 (00000), the gradation level value is turned off in all the subframes to represent 0. When the gradation level value is 1 (00001), only the first subframe is turned on, and the subsequent second to fifth subframes are turned off to represent 1. Similarly, when the gradation level value is 2 (00010), the second subframe is turned on after the first subframe is turned off, and then the third to fifth subframes are turned off again. In this manner, by controlling the turn-off and the turn-on time according to the gradation level value, the luminance according to the gradation level value is artificially sensed by the human eye.

When the frame is switched by time division in this manner, for example, in a case where the gradation level value is around 15 to 16, the turn-off state and the turn-on state are switched in a time of approximately ½ in the frame. For example, in the picture element 14 having the gradation level value of 15 (01111), the first subframe to the fourth subframe (period of 15/31 frames) in the first half are turned on, and the fifth subframe (period of 16/31 frames) in the second half is turned off. On the other hand, in the picture element 14 having the gradation level value of 16 (10000), conversely, the first subframe to the fourth subframe ( 15/31 frames) in the first half are turned off, and the fifth subframe ( 16/31 frames) in the second half is turned on. For this reason, the PWM signal 22A for the picture element 14 having the gradation level value of 15 (01111) and the PWM signal 22A for the picture element 14 having the gradation level value of 16 (10000) have different phases in 100% of one frame period.

In such a case, the turn-off state and the turn-on state continue continuously in a relatively long period of the first to fourth subframes and the fifth subframe, respectively. In particular, when the first half subframe and the second half subframe are distinguished, a phenomenon in which the luminance is reversed between the gradation level values of 15 and 16 occurs in both subframes. For this reason, in a video or the like having gradually changing gradation levels such as gradation, this reverse luminance may occur as a black streak. This may occur not only at 15 to 16, but also at a gradation level value of 7 to 8 and a gradation level value of 23 to 24, where similar gradation level conversion occurs in a shorter period of time in the first half subframe. For example, the PWM signal 22A for the picture element 14 having the gradation level value of 7 (00111) and the PWM signal 22A for the picture element 14 having the gradation level value of 8 (01000) have different phases in approximately 50% of one frame period. Furthermore, the PWM signal 22A for the picture element 14 having the gradation level value of 23 (10111) and the PWM signal 22A for the picture element 14 having the gradation level value of 24 (11000) also have different phases in approximately 50% of one frame period.

This phenomenon does not simply occur due to switching between 0 and 1, but also occurs due to characteristics of the liquid crystal. The picture element pitch of the liquid crystal decreases to several μm as the technology improves. For this reason, at the switching timing of the gradation level value, the reflectance of the liquid crystal element cannot be appropriately controlled due to the influence of the electric field developed beside the adjacent picture element, and the black streak is generated in the region where the period in which the phase is different is long as described above (for example, a region having different phases in approximately 50% or more of one frame period).

In order to lower the visibility of a black streak (digital disclination) caused by the phase difference in the gradation level value, the gamma correction circuit 221 performs gamma correction, and the noise imparting circuit 222 imparts noise to the gradation level value.

Note that, although the above is a description of the luminance, it is a matter of course that the present disclosure is not applied only to the grayscale video. For example, each picture element 14 may include a color filter. By switching the light emission state by time division of the luminance value for each color as described above, it is also possible to cope with a video of full color or the like.

### [Gamma Correction]

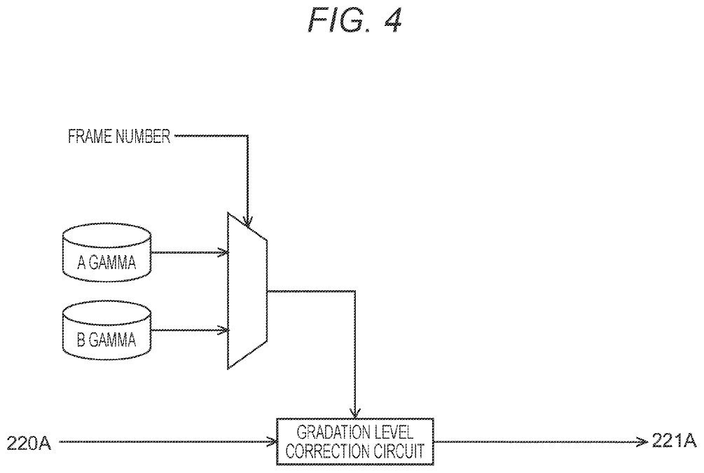

FIG. 4 is a block diagram illustrating an example of the gamma correction circuit 221 according to an embodiment. The gamma correction circuit 221 includes a gradation level correction circuit. The gradation level correction circuit performs gamma correction on input gradation level data 220A on the basis of a gamma table represented by a lookup table (LUT), and outputs the corrected gradation level data as gradation level data 221A.

In the present embodiment, a plurality of LUTs for gamma correction is provided. The LUT may be saved in the gamma correction circuit 221. As another form, the LUT may be stored in a storage unit (not illustrated) provided in the signal processing circuit 22 or the drive circuit 2.

The gamma correction circuit 221 switches and converts the plurality of LUTs according to the frame number. For example, as illustrated in FIG. 4, the gamma correction circuit 221 converts the gradation level by switching between gamma correction LUT A and gamma correction LUT B. In this manner, by switching the LUT for gamma correction for each frame, gamma correction is performed with a gamma curve different for each frame, and the visibility of the black streak described above is lowered.

In a case where two LUTs are used, each gamma curve may be, for example, a curve in which positive and negative are reversed with respect to a linear gradation level conversion (gradation level conversion is not performed) curve. Furthermore, in a case where there is a gamma curve suitable in advance for display on the display device 1, two gamma curves may be set such that positive and negative are reversed with reference to the gamma curve.

An example of setting some tables will be described below. In the following example, a case where the gamma curve as a reference is linear (straight line) will be described, but similar processing can be executed even if the gamma curve as a reference is a curve. In a case where the reference gamma curve is a curve, it is desirable to perform gradation level conversion similar to the following description on the basis of the output gradation level value.

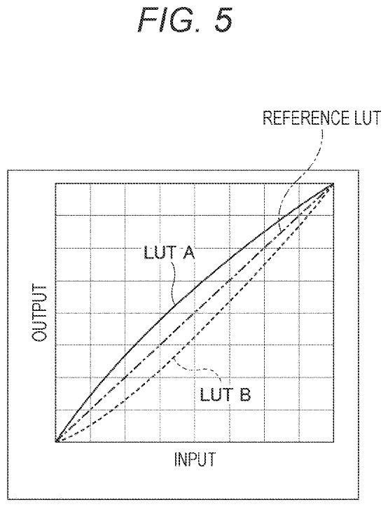

FIG. 5 is a diagram illustrating an example of an LUT for gamma correction. An alternate long and short dash line is a reference LUT, a solid line is a gamma curve indicating LUT A, which is one of the plurality of LUTs, and a broken line is a gamma curve indicating LUT B symmetrical to LUT A with respect to the reference LUT.

For example, the gamma correction circuit 221 executes gamma correction by switching two LUTs for each frame. For example, gamma correction is executed by the gamma curve of LUT A in a certain frame, and gamma correction is executed by the gamma curve of LUT B in the next frame. By switching the LUT for executing the gamma correction in this manner for each frame, the position where the black streak is generated is changed for each frame. Therefore, the visibility of the black streak can be lowered as compared with a case where the black streak is generated at the same position in a plurality of consecutive frames.

For example, in view of characteristics of human eyes, in the low luminance region, the position of the black streak may be changed more greatly than in the high luminance region. Furthermore, this curve may be changed according to the display performance of the display device 1. That is, in the display device 1 having a certain resolution, the curve may change the position of the black streak more greatly than the display device 1 having a lower resolution.

Furthermore, on the contrary, in the high luminance region, it is considered that the black streak caused by the disturbance of the gradation level in the liquid crystal with respect to the actual change in the gradation level is easily sensed by the human. In such a case, in the low luminance region and the high luminance region in which the degree of disturbance by the PWM method is similar, the degree of gradation level correction may be increased in the high luminance region more than the low luminance region in order to more efficiently lower the visibility of the black streak in the high luminance region.

This curve setting is illustrated as some examples, and is not limited thereto, and may be appropriately set by comparing the display device 1 with a sensing result (for example, results of sensory experiments and the like) of the user. In this manner, it is sufficient that the gamma curve is set appropriately on the basis of the characteristics of the environment, the device, and the like. This is not limited to FIG. 5, and this similarly applies to the following examples.

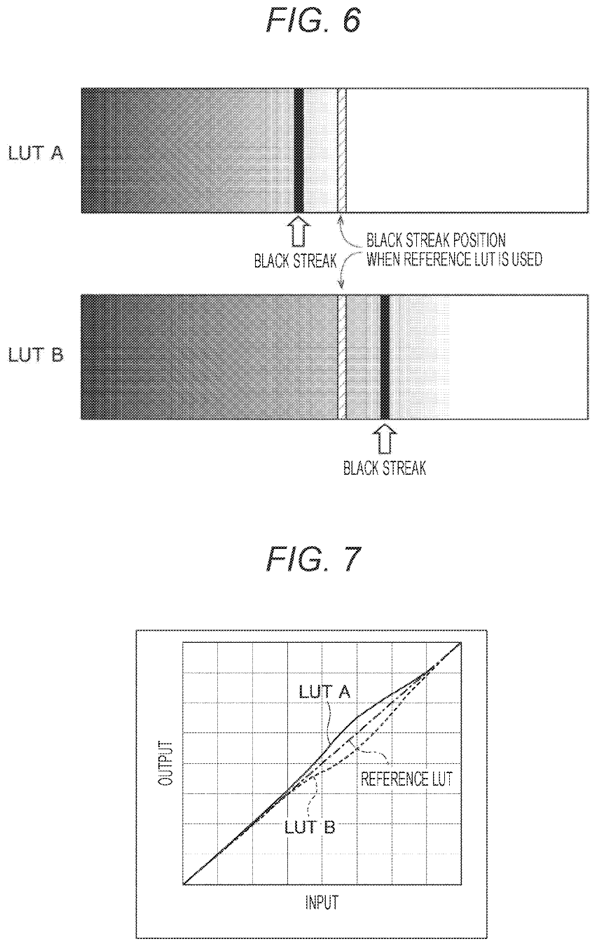

Note that, although the diagram of the LUT including this drawing is emphasized for easy understanding of the difference, the change in the gamma curve may be smaller than that illustrated in the drawing. For example, it is sufficient that the curve is a curve in which the position of the black streak is shifted by several pixels (for example, to five pixels) in a case where the gamma correction is performed in each LUT illustrated in FIG. 6. Note that the LUT is not limited thereto, and may be an LUT indicating a gamma curve that changes more greatly to the extent that the gamma curve is not unnaturally viewed by the user.

FIG. 6 is a diagram illustrating a position of a black streak in a case where such two gamma correction LUTs are used. This drawing is a diagram in a case where gradation is displayed, and is, for example, a diagram in which the vicinity of the median value of luminance at which a black streak is most likely to appear in a case where gamma correction according to the present embodiment is not performed is enlarged. The upper diagram illustrates a case where the LUT A is used, and the lower diagram illustrates a case where the LUT B is used.

The hatched position is the position of the black streak when the reference LUT is used. With respect to this position, a black streak is generated on the left side in the LUT A, and a black streak is generated on the right side in the LUT B. The positions of the black streaks appear alternately for each frame. By time-integrating the videos and the like in these drawings, the original gradation video and the like are output, and the position of the black streak changes for each frame, so that it is possible to make it difficult to sense the black streak.

Note that, as described above, the diagram in which the gradation position changes extremely is illustrated, but this is emphasized for the sake of description, and it is sufficient, in practice, that an LUT that shifts a black streak to such an extent that cannot be sensed by human eyes is used. For example, an LUT by which the position of the black streak is shifted by about one pixel or two pixels to five pixels may be used.

This is not limited thereto, and the black streak may move more greatly. For example, although FIG. 6 illustrates a diagram in the central portion of the luminance value, a gamma curve that smoothly connects the deviation may be held as an LUT by setting the deviation to about one pixel at ¼ and ¾ of the luminance value and the deviation to about two to three pixels at the median value of the luminance value.

FIG. 7 is a diagram illustrating another example of the LUT. For the reference LUT, the LUT A and the LUT B may not be different curves as a whole, but may be LUTs having different curves for regions where black streaks are likely to appear. For example, as described above, there is a high possibility that a black streak is generated in the region of ½ of the luminance value. In a region including such a region, the LUT A and the LUT B may have different values with respect to the reference LUT.

In this manner, the LUT may be set such that the degree of correction increases in a place where the probability of generation of black streaks is high, and the reference LUT is obtained in other regions. By setting such an LUT, it is possible to set the luminance value in a region other than the region where the black streak is generated as the luminance value of the original video or the like.

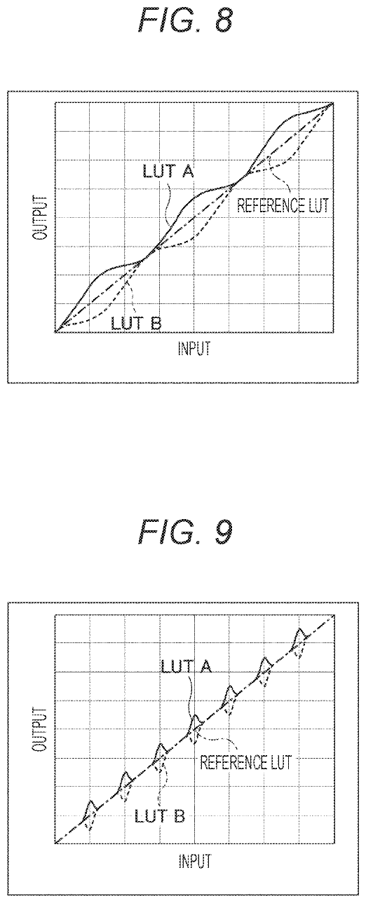

FIG. 8 is a diagram illustrating another example of the LUT. In the LUT A and the LUT B, the curves may be set such that the transition from the reference LUT becomes large in the region where black streaks are likely to appear, for example, the regions of ½, ¼, ¾, ⅛, . . . of the luminance value. In FIG. 8, a similar curve is set in all the regions where the difference between the LUTs increases, but the present invention is not limited thereto.

For example, the LUT may be set such that the difference in corrected luminance increases as the luminance value decreases, or vice versa.

Moreover, as another example, in the region where the luminance value includes ½ of the maximum value, the curve may vary more than the correction value of the luminance value in the region including ¼ and ¾ of the maximum value.

In FIG. 8, there are three regions in which the degree of correction by the LUT is larger than the surroundings, but the present invention is not limited thereto. For example, it may be configured such that the degree of correction is larger than that of the periphery in units of ⅛ with respect to the maximum value of the luminance value, that is, the degree of correction is larger than that of the periphery in seven regions.

FIG. 9 is a diagram illustrating another example of the LUT. Similarly to FIG. 8, processing of shifting the LUT from the reference LUT is performed in a region where black streaks are likely to appear, but a curve equivalent to the reference LUT is obtained in a region other than the region where black streaks are likely to be generated.

Similarly to FIG. 8, for example, in the region of ½ of the maximum value of the luminance value, the LUT may be configured to be capable of performing correction to make a larger variation than in other regions. Moreover, in the regions of ¼ and ¾ of the maximum value, the LUT may be configured capable of performing correction that causes a larger variation than the regions of ⅛, . . . , and the like of the maximum value.

By setting the LUT as illustrated in FIG. 9, it is possible to selectively increase the variation range in the gradation level in which the black streak is generated and to prevent the gradation level variation from occurring in other regions. As a result, for example, it becomes difficult for the user to visually recognize the black streak, and it becomes possible to sense a video closer to the original video or the like in other gradation levels.

Note that, in the examples of FIGS. 5 to 9 described above, a case where two LUTs are provided has been described, but a case where three or more LUTs are provided may be used. For example, in a case where three LUTs are used, the LUT may be changed in three cycles of reference LUT→LUT A→LUT B, or the LUT may be changed in four cycles of LUT A→reference LUT→LUT B→reference LUT using the reference LUT in addition to the LUT A and the LUT B described above.

The present invention is not limited thereto, and an LUT C between the LUT A and the reference LUT and an LUT D between the LUT B and the reference LUT may be further set, and a cycle including the LUT C and the LUT D may be used. As another example, a cycle including both the LUT A and the LUT B of FIG. 8 and the LUT A and the LUT B of FIG. 9 may be used. For example, the gamma curve may be varied in a cycle of LUT A in FIG. 8→LUT B in FIG. 8→LUT A in FIG. 9→LUT B in FIG. 9, or the like.

The combination of the LUTs to be used and the transition of the LUTs are illustrated as examples, and the present invention is not limited thereto. For example, in the above description, LUTs that swing positive and negative with respect to the reference LUT are alternately used, but the present invention is not limited thereto, and gamma curves smoothly used may be transitioned, such as positive and large deflection width→positive and small deflection width→reference LUT→negative and small deflection width→negative and large deflection width→negative and small deflection width→reference LUT→positive and small deflection width.

As described above, according to the gamma correction of the present embodiment, by changing the gamma curve for each frame, the correction amount of the gradation level in which the black streak is easily visible can be increased, and the correction amount of the gradation level in which the black streak is hardly visible can be decreased. Therefore, the visibility of the black streak can be lowered. Moreover, since it is avoided to uniformly change the gradation level for all the gradation levels, it is possible to avoid occurrence of flicker due to gamma correction for lowering the visibility of black streaks.

### [Noise Imparting]

As described above, depending on the gradation level, in a case where the period in which the phase of the PWM signal 22A for each of two adjacent picture elements is different is greater than or equal to a predetermined period (for example, 50% or more of one frame period), a black streak is generated between the two picture elements. The noise imparting circuit 222 imparts noise to the gradation level data in the gradation level where such a black streak is generated, thereby lowering the visibility of the black streak.

In a case where the gradation level output from each picture element 14 is a gradation level in which a black streak can be generated, the noise imparting circuit 222 imparts noise to the gradation level data. The gradation level in which the black streak can be generated is a gradation level in which the phase greatly changes in a case where the gradation level value is represented digitally as in the case of gamma correction.

For example, in a case where the digital representation of the gradation level value is represented as in FIG. 3, noise is imparted to gradation level data for the picture element 14 having a gradation level value of 15. Moreover, noise may be imparted to gradation level data for the picture element 14 having a gradation level value of 7 and the picture element 14 having a gradation level value of 23. In this manner, the noise imparting circuit 222 imparts noise to the gradation level data of the picture element 14 that outputs the gradation level value serving as the boundary where the black streak can be generated.

As a form different from the above, noise may be imparted to gradation level data for the picture elements 14 having gradation level values of 16, 8, and 24. As still another form, noise may be imparted to gradation level data for the picture elements 14 having gradation level values of 15, 16, 7, 8, 23, and 24.

As described above, the conversion of the gradation level data is executed, for example, in the gradation level around the gradation level values of 15 and 16 or the like Quantitatively indicating this, in a case where the maximum value of the gradation level data is n (n is any natural number), noise may be imparted to the gradation level data of the picture element having the gradation level value of floor ((n−1)/2). Here, floor ( ) represents a floor function.

The noise imparting circuit 222 may impart noise to gradation level data of a picture element (however, a picture element having a gradation level value less than the maximum gradation level value) having a gradation level value of A*2^{m}−1 (A and m are each any natural number). As another example, the gradation level value of floor ((n−1)/2) or A*2^{m}−1 described above may be stored in a storage circuit (not illustrated), and noise may be imparted to the gradation level data in a case where the gradation level value is applied.

The noise imparting circuit 222 may determine the strength of noise to be imparted on the basis of the gradation level value for imparting noise. For example, in the case that the gradation level value is indicated as illustrated in FIG. 3, the basic value may be set to 1 when the gradation level value is 7, the basic value may be set to 4 when the gradation level value is 15, and the basic value may be set to 2 when the gradation level value is 23. The noise imparting circuit 222 imparts noise to the gradation level data on the basis of the basic value. For example, the noise imparting circuit 222 imparts noise between −4 to +4 to gradation level data of the picture element 14 having a gradation level value of 15.

The noise imparting circuit 222 imparts this noise for each frame. For example, in a case where noise of −4 is imparted to gradation level data of a certain picture element 14 having a gradation level value of 15 in a certain frame, noise of +4 may be imparted in the next frame. That is, in this case, the gradation level value of the picture element 14 is 11 in a certain frame and 19 in the next frame. In this manner, the positive and negative of the noise to be imparted may be switched for each frame.

As another example, the noise imparting circuit 222 may repeat the noise to be imparted as positive basic value→0→negative basic value→0→positive basic value.

Furthermore, the noise imparting circuit 222 may impart noise whose absolute value is equal to or less than the basic value instead of the basic value. For example, in a case where the basic value is 4, the noise imparting circuit 222 may vary the noise to be imparted to a certain picture element 14 such as +2→−2→+2 or +2→0→−2, or may vary the noise to be imparted to a different picture element 14 such as +3→−3→+3 or +3→0→−3.

As another example, the noise imparting circuit 222 may impart random noise within ±basic value for each frame without considering positive and negative.

As another example, the noise imparting circuit 222 may impart noise for each frame so as to smoothly transition from the positive basic value to the negative basic value like a triangular wave or a sine wave. For example, with respect to the gradation level value of which the basic value is 4, noise to be imparted such as +4→+3→+2→+1→0→−1→ . . . →−4→−3→→ . . . →+3→+4 or the like may be changed.

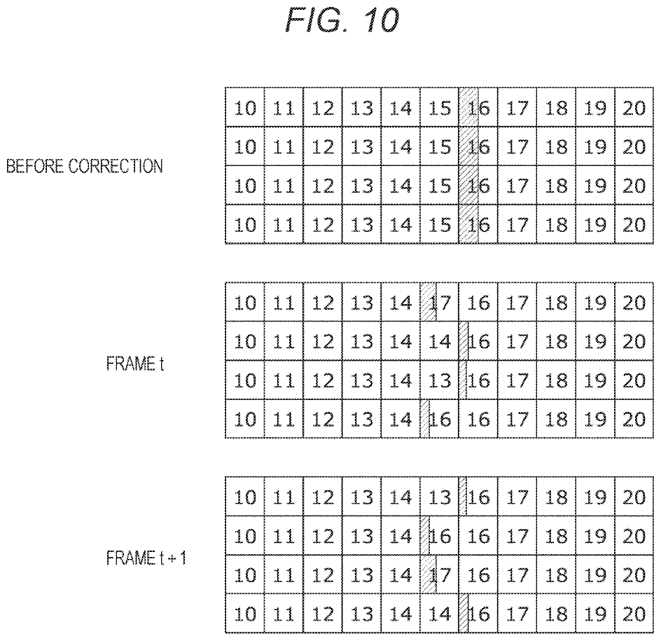

FIG. 10 is a diagram illustrating an example in which positive and negative values are alternately imparted as noise. In this drawing, for example, in a gradation video or the like having 32 gradation levels, portions around gradation level values of 15 and 16 are enlarged. A hatched portion is a region of the picture element 14 where a difference in gradation level values causing a black streak can occur, and a thickness indicates a magnitude (strength and/or thickness) of an influence of the black streak. In this example, the noise imparting circuit 222 imparts noise to the gradation level data of the picture element 14 having the gradation level value of 15.

Before the correction, a black streak is generated between the gradation level values of 15 and 16.

In the frame t, for example, the noise imparting circuit 222 imparts noise of +2 to the uppermost line, noise of −1 to the next line, noise of −2 to the next line, and noise of +1 to the lowermost line. In this case, the position of the picture element 14 that can be a black streak is shifted for each line. Then, the influence is also smaller than the influence between the gradation level values of 15 and 16.

In the next frame (t+1), the noise imparting circuit 222 imparts noise whose positive and negative is opposite to that of the noise imparted in the frame t. By reversing the imparted noise in positive and negative in this manner, a place where a black streak can be generated is switched between the frame t and the frame (t+1). Furthermore, as described above, the degree of influence is less than the disturbance generated between the gradation level values of 15 and 16.

As a result, as a result of time integration that can be sensed by human eyes, black streaks do not occur as before correction, but visibility of black streaks can be lowered on average.

As described above, according to the noise imparting according to the present embodiment, it is possible to lower the visibility of the black streak. Furthermore, similarly to the gamma correction described above, since a uniform value is not added to or subtracted from the gradation level value of the entire image, it is possible to lower the visibility of the black streak while suppressing the occurrence of flicker.

Note that, as described in the configuration of signal processing circuit 22, any of gamma correction circuit 221 and noise imparting circuit 222 may be disposed first, or any of them may not be disposed. That is, only gamma correction may be executed or only noise imparting may be executed. Furthermore, noise imparting may be executed after gamma correction, or gamma correction may be executed after noise imparting.

### [Flow of Each Correction Process]

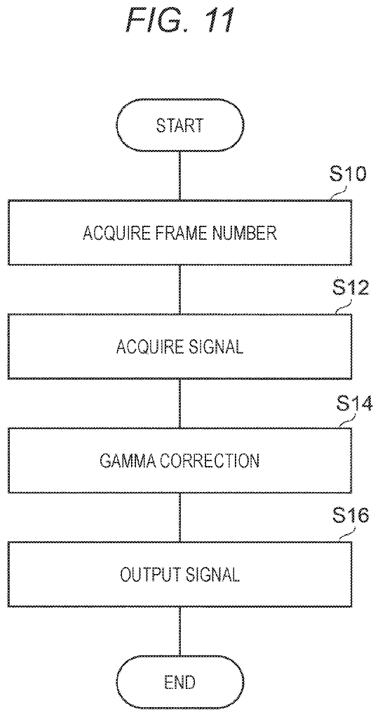

FIG. 11 is a flowchart illustrating processing of the gamma correction circuit 221 according to an embodiment.

The gamma correction circuit 221 first acquires a frame number (S10).

Next, the gamma correction circuit 221 acquires a signal (S12). This signal is, for example, a signal representing a gradation level value of a video or the like for each picture element. In a case where gamma correction is executed after noise imparting, the signal is a signal output from the noise imparting circuit 222. Note that S10 and S12 may be performed in the reverse order or at the same timing. It is sufficient that the frame number and the signal can be received in association with each other.

Next, the gamma correction circuit 221 performs gamma correction (S14). As described above, for example, the gamma correction is executed on the basis of a plurality of LUTs set for each frame.

Next, the gamma correction circuit 221 outputs the gamma-corrected signal (S16).

In this manner, the gamma correction circuit 221 switches the gamma correction based on the plurality of different LUTs depending on the frame, and outputs the gamma correction.

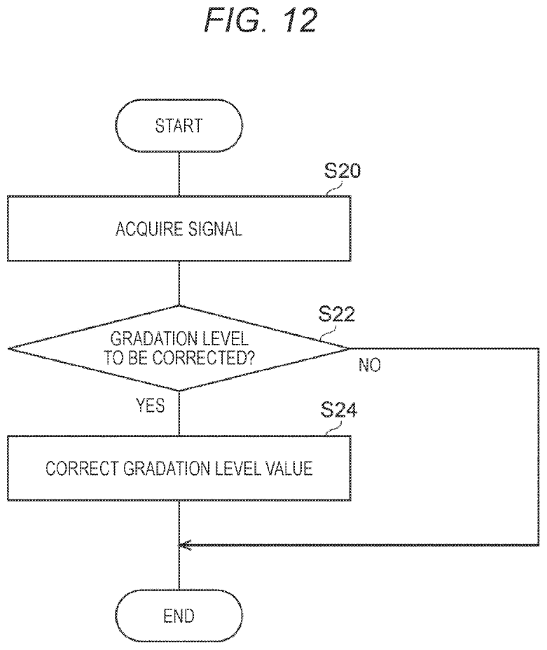

FIG. 12 is a flowchart illustrating processing of the noise imparting circuit 222 according to an embodiment.

The noise imparting circuit 222 first acquires a signal (S20). This signal is, for example, a signal representing a gradation level value of a video or the like for each picture element. In a case where noise imparting is executed after gamma correction, the signal is a signal output from the gamma correction circuit 221.

Next, the noise imparting circuit 222 determines whether or not the gradation level value in each picture element 14 is a gradation level value to be corrected (S22).

Next, when in a case of the gradation level value to be corrected (S22: YES), the noise imparting circuit 222 corrects the gradation level value (S24). The processing from S22 to S24 is executed for all the picture elements 14 to be output. These processes may be sequentially executed for each picture element 14 or may be executed in parallel.

In a case of not the corrected gradation level value or the gradation level value to be corrected (S22: NO), the noise imparting circuit 222 outputs the gradation level value in the acquired signal without changing the gradation level value (S26). Then, light having an intensity based on the signal is output from the picture element 14 on the basis of the output gradation level value.

These circuits may be implemented by a dedicated circuit that implements the processing, or may be implemented by a general-purpose processing circuit (processor). That is, it may be implemented as a dedicated analog or digital circuit such as an application specific integrated circuit (ASIC) or the like, or may be implemented such that software processing is specifically implemented by hardware resources by an analog or digital circuit having various functions such as a central processing unit (CPU) or the like. In the case of processing by software, a program or the like for executing the processing may be stored in a storage unit (not illustrated). Furthermore, in a case where a dedicated circuit is used, each component may be implemented as a programmable circuit such as a field programmable gate array (FPGA).

The technology described in the present disclosure can be applied to general liquid crystal panels that are digitally driven, such as projection-type projectors, televisions, and the like, for example. The technology related to this display can be applied to a display unit such as a digital camera, a digital video camera, a display of a computer, a tablet terminal, a wristwatch terminal, a spectacle terminal, a smartphone, a feature phone, or the like as some non-limiting examples. The display unit may incorporate a touch panel.

Furthermore, the technology described in the present disclosure can also be applied to a phase modulation (PM) method display device. In a case where the PM method signal is input and output, the drive circuit executes similar processing as described above, for example, for a plurality of gradation levels in which the phase is largely switched in a range in which the difference in gradation level is small (for example, the gradation level difference is 1/32 or less of the minimum value and the maximum value or the like) similarly to the PWM method signal. Specifically, the drive circuit switches a gamma curve or imparts random noise. As a result, such disturbance of the liquid crystal in the gradation level can be suppressed.

The embodiments described above may have the following forms.

(1)

A drive circuit that drives picture elements in a display device arranged in a matrix, the drive circuit including
a noise imparting unit that imparts one of a plurality of correction values to gradation level data of a picture element of the picture elements in a case where a gradation level of the picture element is a predetermined gradation level.

(2)

The drive circuit according to (1),
in which the gradation level data is a signal encoded in a pulse width modulation (PWM) format or a phase modulation (PM) format indicating control of continuing an on state or an off state of the picture element in a period of subframes time-divided in one frame, and control is performed such that the picture element emits the signal encoded along a time series.

(3)

The drive circuit according to (2),
in which the noise imparting unit sets a basic value on the basis of a predetermined gradation level value, and imparts a correction value whose absolute value is within the basic value to the gradation level data of the picture element.

(4)

The drive circuit according to (3),
in which a maximum value of the gradation level data is n (n is any natural number), and the predetermined gradation level includes at least a gradation level indicating a gradation level value of floor ((n−1)/2).

(5)

The drive circuit according to (4),
in which the predetermined gradation level includes a plurality of gradation level values, and
a correction value is imparted to the gradation level data of the picture element of the gradation level of floor ((n−1)/2) on the basis of the basic value larger than the picture element of another predetermined gradation level.

(6)

The drive circuit according to any one of (3) to (5),
in which the noise imparting unit imparts a correction value obtained by reversing positive and negative of a correction value imparted to a previous frame to the gradation level data of each of the picture elements to which the correction value is imparted.

(7)

The drive circuit according to any one of (3) to (5),
in which the noise imparting unit imparts a correction value that randomly varies to the gradation level data of the picture element.

(8)

The drive circuit according to any one of (3) to (5),
in which the noise imparting unit imparts a correction value that periodically varies to the gradation level data of each of the picture elements to which the correction value is imparted.

(9)

The drive circuit according to (3),
in which the noise imparting unit imparts a correction value to the gradation level data of the picture element in a case where a period in which phases of the gradation level data in the PWM format for two picture elements adjacent to each other in a same frame are different is a predetermined period or longer.

(10)

The drive circuit according to any one of (1) to (9), further including
a gamma correction unit that executes gamma correction on the gradation level data, the gamma correction unit switching a plurality of gamma curves for each frame.

(11)

The drive circuit according to (10),
in which the gamma correction unit executes gamma correction on the basis of a gamma curve for correcting gradation levels having same values in positive and negative from a reference gamma curve.

(12)

The drive circuit according to (11),
in which the gamma correction unit executes gamma correction from the reference gamma curve on the basis of a gamma curve in which at least a central gradation level value is a value different from the reference gamma curve.

(13)

The drive circuit according to (12),
in which the gamma correction unit executes gamma correction at least on the basis of a gamma curve having a gradation level different from the reference gamma curve in a gradation level in which a period in which phases of the gradation level data in the PWM format for two picture elements adjacent to each other in a same frame are different is a predetermined period or longer.

(14)

The drive circuit according to (12),
in which the gamma correction unit executes gamma correction at least on the basis of a gamma curve having a gradation level in which a difference from the reference gamma curve is larger than previous and subsequent gradation level values in a gradation level in which a period in which phases of the gradation level data in the PWM format for two picture elements adjacent to each other in a same frame are different is a predetermined period or longer.

(15)

A drive circuit that drives picture elements in a display device arranged in a matrix, the drive circuit including
a gamma correction unit that executes gamma correction on gradation level data for a picture element of the picture elements, the gamma correction unit switching a plurality of gamma curves for each frame.

(16)

A display device including the drive circuit according to any one of (1) to (15).

(17)

A drive method for controlling a display device by controlling the drive circuit according to any one of (1) to (15).

Aspects of the present disclosure are not limited to the above-described embodiments, but include various conceivable modifications, and the effects of the present disclosure are not limited to the above-described contents. The components in each embodiment may be appropriately combined and applied. That is, various additions, modifications, and partial deletions can be made without departing from the conceptual idea and gist of the present disclosure derived from the contents defined in the claims and equivalents thereof.

### REFERENCE SIGNS LIST

1 Display device
10 Display panel
12 Picture element region
14 Picture element
16 Data line
18 Scanning line
20 Drive circuit
22 Signal processing circuit
24 Controller
26 Horizontal drive circuit
28 Vertical drive circuit
220 Preprocessing circuit
221 Gamma correction circuit
222 Noise imparting circuit
223 Frame memory
224 Write circuit
225 Read circuit
226 Decoder

What is claimed is:

1. A drive circuit that drives picture elements in a display device arranged in a matrix, the drive circuit comprising
a noise imparting unit that imparts one of a plurality of correction values to gradation level data of a picture element of the picture elements in a case where a gradation level of the picture element is a predetermined gradation level.

2. The drive circuit according to claim 1,
wherein the gradation level data is a signal encoded in a pulse width modulation (PWM) format or a phase modulation (PM) format indicating control of continuing an on state or an off state of the picture element in a period of subframes time-divided in one frame, and
control is performed such that the picture element emits the signal encoded along a time series.

3. The drive circuit according to claim 2,
wherein the noise imparting unit sets a basic value on a basis of a predetermined gradation level value, and imparts a correction value whose absolute value is within the basic value to the gradation level data of the picture element.

4. The drive circuit according to claim 3,
wherein a maximum value of the gradation level data is n (n is any natural number), and the predetermined gradation level includes at least a gradation level indicating a gradation level value of floor ((n−1)/2).

5. The drive circuit according to claim 4,
wherein the predetermined gradation level includes a plurality of gradation level values, and
a correction value is imparted to the gradation level data of the picture element of the gradation level of floor ((n−1)/2) on a basis of the basic value larger than the picture element of another predetermined gradation level.

6. The drive circuit according to claim 3,
wherein the noise imparting unit imparts a correction value obtained by reversing positive and negative of a correction value imparted to a previous frame to the gradation level data of each of the picture elements to which the correction value is imparted.

7. The drive circuit according to claim 3,
wherein the noise imparting unit imparts a correction value that randomly varies to the gradation level data of the picture element.

8. The drive circuit according to claim 3,
wherein the noise imparting unit imparts a correction value that periodically varies to the gradation level data of each of the picture elements to which the correction value is imparted.

9. The drive circuit according to claim 3,
wherein the noise imparting unit imparts a correction value to the gradation level data of the picture element in a case where a period in which phases of the gradation level data in the PWM format for two picture elements adjacent to each other in a same frame are different is a predetermined period or longer.

10. The drive circuit according to claim 1, further comprising
a gamma correction unit that executes gamma correction on the gradation level data, the gamma correction unit switching a plurality of gamma curves for each frame.

11. The drive circuit according to claim 10,
wherein the gamma correction unit executes gamma correction on a basis of a gamma curve for correcting gradation levels having same values in positive and negative from a reference gamma curve.

12. The drive circuit according to claim 11,
wherein the gamma correction unit executes gamma correction from the reference gamma curve on a basis of a gamma curve in which at least a central gradation level value is a value different from the reference gamma curve.

13. The drive circuit according to claim 12,
wherein the gamma correction unit executes gamma correction at least on a basis of a gamma curve having a gradation level different from the reference gamma curve in a gradation level in which a period in which phases of the gradation level data in the PWM format for two picture elements adjacent to each other in a same frame are different is a predetermined period or longer.

14. The drive circuit according to claim 12,
wherein the gamma correction unit executes gamma correction at least on a basis of a gamma curve having a gradation level in which a difference from the reference gamma curve is larger than previous and subsequent gradation level values in a gradation level in which a period in which phases of the gradation level data in the PWM format for two picture elements adjacent to each other in a same frame are different is a predetermined period or longer.

15. A drive circuit that drives picture elements in a display device arranged in a matrix, the drive circuit comprising
a gamma correction unit that executes gamma correction on gradation level data for a picture element of the picture elements, the gamma correction unit switching a plurality of gamma curves for each frame.
